(19) United States
(12) Patent Application Publication
(10) Pub. No.: US 2009/0040933 A1
(43) Pub. Date: Feb. 12, 2009

(54) AUTOMATICLLY ACTIVATED QUALITY MEASUREMENT

(76) Inventors: Norbert Boll, Munchen (DE); Sonke Rosner, Unterhaching (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/658,374

(22) PCT Filed: Jul. 26, 2005
(86) PCT No.: PCT/EP2005/053633

§ 371 Date: Feb. 6, 2007

(30) Foreign Application Priority Data
Aug. 9, 2004 (EP) 04018875.7

(51) Int. Cl. H04L 12/24; H04L 12/26

(52) U.S. Cl. 370/242

(57) ABSTRACT

According to one aspect of the invention, determination of data that allows conclusions to be drawn about the cause of a disturbance is activated. The cause of the disturbance is then determined by a diagnostic application that takes the data into account. Data determination is automatically deactivated by taking into account a configurable time limit or after a fixed period of time. Activation of data determination is chronologically closely linked to the occurrence of the disturbance such that particularly meaningful data is determined for determining the cause.

### CROSS REFERENCE TO RELATED APPLICATIONS

This application is the US National Stage of International Application No. PCT/EP2005/053633, filed Jul. 26, 2005 and claims the benefit thereof. The International Application claims the benefits of European application No. 04018875.7 EP filed Aug. 9, 2004, both of the applications are incorporated by reference herein in their entirety.

### FIELD OF INVENTION

The present invention relates to an automatically activated quality measurement.

### BACKGROUND OF INVENTION

A reference architecture of a Telecommunications Management Network (TMN) for monitoring and controlling a network for telecommunications applications is described in International Standard M.3010 (February 2000) of the ITU-T, which starts from the assumption that the network controlled by the TMN comprises different types of network element that are usually controlled using various communication mechanisms (i.e. protocols, messages, management information—also called object models).

### SUMMARY OF INVENTION

This TMN includes the following functionalities:
Operations Systems Function (OSF), which implements the “actual” management of the telecommunications network.
Workstation Function (WSF) which is used to display the control processes and the network status for a human user of the TMN.
Network Element Function (NEF) which represents an interface for control of the telecommunications functions of the network elements. The interface defines the specific communications mechanism of the relevant network element which may possibly not be standardized. The totality of all management information of the NE is referred to as the Management Information Base (MIB) of the NE. It will also be referred to below as the NE-MIB.
Transformation Function (TF) which is used for connecting components with different communication mechanisms and especially for linking to the TMN network elements which do not feature a standardized NEF. It is also referred to in Standard M.3010 (May 1996) as the Mediation Function or as the Q-Adaption function.

Furthermore the functionalities are classified as far as possible, in accordance with the FCAPS scheme, into the following groups:

F=Fault

C=Configuration

A=Accounting

P=Performance

S=Security

The functions are implemented by physical products, which can typically be embodied as network element (NE), operations system (OS), application, terminal, router, switch, database server or computer program (more precisely computer program product), but of course are not limited to these products.

The function NEF is usually assigned to an NE, whereas the functions OSF and WSF are mostly assigned to an OS. Usually an OS is assigned a plurality of NEs, with the OS mostly being centralized while the NEs are distributed in the network at a plurality of locations.

A Data Communication Network (DCN) can be provided between NE and OS for transfer of information. The transfer follows the principles of the transport service as described in the lower layers of the ISO/OSI Reference Model in International Standard X.200.

An OS can comprise a number of programs—also called applications or software. The programs can be embodied for example as management applications for controlling different network technologies of a communication network, of which in each case an application-specific subset of the resources of the network will be modeled, visualized and controlled for the respective technology.

The programs are executed by hardware (e.g. processor, I/O module) which is provided in the products. This execution is supported by support software (e.g. multitasking or multithreading operating system, database system, windows system).

The performance functionality is typically implemented in the products initially by quality-relevant data, such as quality and/or protocol data in the physical layer (e.g. subscriber interface) or logical layer (e.g. IP, ATM), or by measurement data of the line monitoring of the subscriber interface being detected in the network elements. This data is subsequently transmitted via the DCN to the OS and is linked there into at least one application for precise determination of the error search or for analysis of the performance restriction (e.g. an ILDA=Intelligent Line Diagnostics Application).

It is clear from the aforementioned that the implementation of the architecture described in practical solutions, as a result of the distinctive distributed nature of the system and the plurality of different system components and requirements, represents a highly complex technical problem to be resolved.

An object of the invention is to recognize at least one of the existing problems and to resolve it by specifying at least one directive for technical actions.

The invention is based on the following knowledge:
Because of the volume of data involved, data recording is very frequently not activated. The quality/protocol data and the measurement data of line monitoring can therefore frequently not be included in a chronologically later error cause and analysis procedure by an application for the precise tracing and analysis of the disturbance restricting the quality, if the quality and protocol data recording was not activated at the time at which the quality reduction occurred, or if the measurement data for the line was not requested and stored.
The recording of quality and protocol data can only be started if requested by a user in the network element (e.g. DSLAM). Simultaneous recording of the quality/protocol data of a network element in advance is problematic for reasons of storage capacity and the performance of the network element. Even if the storage capacity and the performance of the network element were to be sufficient, the reading out and evaluation of all data would unnecessarily use up network and processing capacity.
The line monitoring measurement data is recorded at the request of the user and only ever produces a snapshot of the measured values at the current point in time. Thus, on account of the manual intervention by an operator, the data is mostly recorded at the incorrect time, so that the inclusion of this important data for fault tracing and analysis procedures at a later time is rarely possible or not possible at all because the data is not available.

A solution for this problem situation recognized by the invention, as well as advantageous embodiments of this solution, are specified in the claims.

### BRIEF DESCRIPTION OF THE DRAWINGS

The invention is explained below on the basis of exemplary embodiments which are also shown in the figures. It should be emphasized that the embodiments of the invention illustrated, despite their in part very detailed presentation, are only to be seen as examples and should not be taken as imposing any restrictions. The figure shows:

FIG. 1 a typical arrangement, comprising a central operations system OS with applications A for control of decentralized elements NE of a communication network KN

### DETAILED DESCRIPTION OF INVENTION

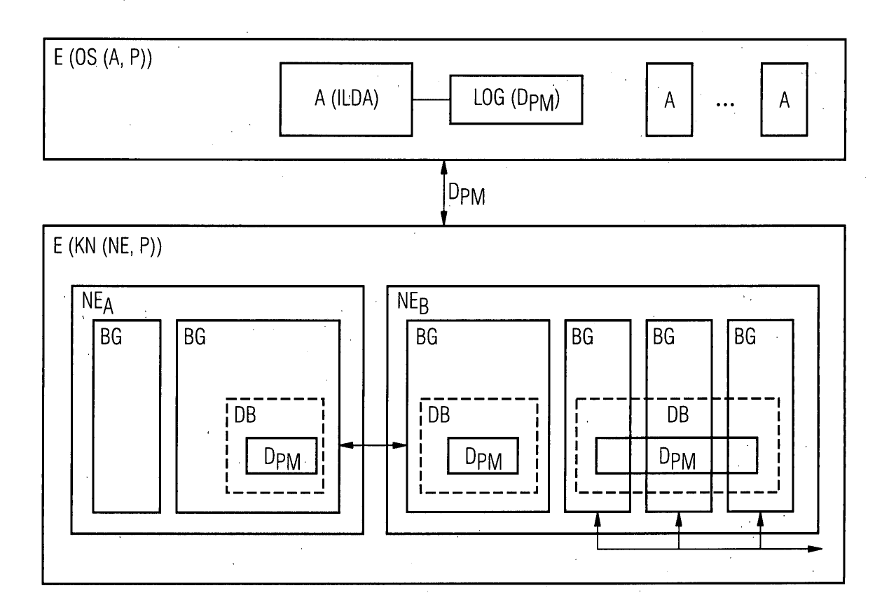

The embodiment of the invention will furthermore also be explained with the aid of the arrangement shown in FIG. 1, which comprises a plurality of physical products E arranged in a distributed configuration. The products E are embodied for example as distributed decentralized network elements NE_{A}, NE_{B} of a communication network KN or as a central operations system OS with applications A for control of the decentralized elements NE of the communication network KN. At least one of the applications A is embodied for example as an ILDA (=Intelligent Line Diagnostics Application) for intelligent diagnosis of disturbances of the communication network KN.

The products E comprise hardware—especially processors and storage means—with the aid of which especially those products E are executed which are embodied as computer program products P or as programs P. The hardware can also correspond directly to the products E, for example as an Application Specific Integrated Circuit (ASIC) or similar physical product E.

The products embodied as applications A can be assigned to the TMN function blocks Operations Systems Function (OSF) and Workstation Function (WSF), the products embodied as network elements NE to the TMN function block Network Element Function (NEF).

The operations system OS and the network element NE are connected by a data network referred to in technical circles as a Data Communication Network (DCN), via which for example the data D_{PM} embodied as quality/protocol monitoring data and/or measurement data is transmitted to the application ILDA.

The network elements NE each comprise at least one module BG. The data D_{PM} can be collected and at least partly stored in the two Network Elements NE. The data D_{PM} is for example stored in databases DB, which can also be arranged distributed over a number of modules BG, or can be stored in logs LOG.

One embodiment of performance functionality, taking into account the invention, typically appears so that subsequent actions are executed automatically and without manual operator intervention e.g. by the application ILDA or by the network element for precise error tracing and analysis of the quality restriction:

a) Automatic detection of a reduction in performance or quality on a subscriber line as soon as the reduction occurs by analysis of the error image and correlation of the current and historical alarm and event messages of a network element NE.
Performance and quality reductions can be detected for example in ADSL (Asymmetric Digital Subscriber Line) on the basis of the following conditions, which mostly also lead to a corresponding alarm being signaled to the operations system OS:
   Signal-to-noise ratio (SNR) falling below a specific threshold, with said threshold able to be configured where possible. An alarm is triggered when this threshold is reached, but no retraining is yet initiated at ADSL level.
   Bit error rate (CRC error) exceeding a specific threshold value, with said threshold able to be configured where possible.
Advantageously a reduction of the line quality is not detected by the operating personnel, as with earlier systems, but automatically by the network element NE or an application A of the operations system OS. Particularly attractive advantages are produced if this step is undertaken by the network element NE, since this step is also performed for a disturbance in the DCN at a point close in time to the initiating event.

b) Automatically starting the recording and summing of the data embodied as quality/protocol monitoring data D_{PM} on physical and protocol layer for the subscriber line in the network element NE, on which a reduction in performance and quality was detected.
As an alternative or in addition: Automatic storage of the data D_{PM} embodied as measurement data for example(for ADSL e.g. bits per BIN, SNR per BIN) during line monitoring within the network element NE and/or immediate transfer to the operations system OS.
Advantageously the data D_{PM} is recorded almost simultaneously with the occurrence of the reduction in performance or quality by being started automatically by an application A of the operations system OS or by the network element NE.
It is especially good that the measurement data is stored even if the connection to the operations system OS or a definitive application A of the operations system OS itself is faulty.

c) Cyclic request for the data D_{PM} buffered in the network element by the application ILDA for precise error tracing and analysis of the quality restriction for the case in which the data D_{PM} cannot automatically be sent immediately.

d) Recording of the data in a log LOG, where possible over a longer period.

Advantage: Quality/protocol and line monitoring data D_{PM} is determined over a longer period, which increases the likelihood of the application ILDA being able to determine the precise cause of the reduction in performance and quality.

e) Automatic evaluation of the alarm log as from the time of the reduction in performance and quality of a subscriber interface, with the inclusion of the data D_{PM} (quality and protocol monitoring data or line monitoring measurement data) stored in the log LOG by analysis and correlation of the data D_{PM} by the application ILDA, to ascertain the precise error causing the reduction in performance or quality.

Advantage: The cause of the reduction in performance or quality can be determined more rapidly by the application ILDA. Also, for disturbances reported subsequently by customers using the subscriber interface, it is possible to refer back to monitoring data, since in accordance with the invention the monitoring of the subscriber interface or the detection of the line monitoring measurement data is activated automatically at this point.

f) Automatic deactivation of the quality/protocol and measurement data recording for the subscriber interface involved by one of the applications A of the operations system OS or by the network element NE, for example through a time restriction—configurable where possible—or after a fixed period (e.g. after 24 hours), after the reduction in performance or quality of the subscriber interface is no longer occurring.
Advantage: Automatic restriction of the amount of data D_{PM}, which, above all for network elements NE with limited storage capacity, is a very good advantage.

A plurality of advantages is associated with the invention:
For an activation controlled by the application A or by the network element NE, only the relevant data D_{PM} is recorded.
The costs incurred through the inability of a network element NE to be operated are reduced to the minimum. There are economic benefits for a network operator produced by the reduction of the OPEX (OPerational EXpenses).
Implementing the invention does not require any basic modifications to the previous prior art; the invention is basically able to be added subsequently as a module—especially as a modified or additional computer program product.
The time of implementation is independent of the time of implementation of the other functions.
The invention ensures that only a slight load is imposed on the individual components of the overall system and thereby the stability of the overall system is increased.

Finally it should be noted that the description of the components of the system relevant for the invention is fundamentally not to be seen as in any way restrictive as regards a specific physical realization or assignment. For a relevant person skilled in the art it is especially evident that the invention can be implemented partly or completely in software and distributed over a number of physical products/computer program products.

1.-10. (canceled)

11. A method for determining a cause of a disturbance in a communication network having a product by which data is determined and having a diagnostic application, comprising:
detecting an occurrence of the disturbance;
automatically activating a determination of the data in result of the detection;
transferring the data to the diagnostic application; and
determining the cause by the diagnostic application by using the transferred data

12. The method as claimed claim 11, wherein the determination is started in accordance with a criterion.

13. The method as claimed claim 12,
wherein the product is embodied as a network element of the communication network, and
wherein the criterion is a signal-to-noise ratio dropping below a specific threshold value.

14. The method as claimed claim 13, wherein the threshold value is configurable.

15. The method as claimed claim 14, wherein the detection and the activation occur in the product.

16. The method as claimed claim 12,
wherein the product is embodied as a network element of the communication network, and
wherein the criterion is a bit error rate exceeding a specific threshold value.

17. The method as claimed claim 16, wherein the threshold value is configurable.

18. The method as claimed claim 17, wherein the detection and the activation occur in the product.

19. The method as claimed claim 12, wherein the data is embodied as quality monitoring data.

20. The method as claimed claim 12, wherein the data is embodied as protocol monitoring data.

21. The method as claimed claim 12, wherein the data is embodied as measurement data.

22. The method as claimed claim 12, wherein the determination of the data is automatically deactivated.

23. The method as claimed claim 22, wherein the determination of the data is automatically deactivated using a configurable time limit.

24. The method as claimed claim 22, wherein the determination of the data is automatically deactivated after a fixed period of time.

25. A product, comprising:
a detector that detects an occurrence of a disturbance;
an activator that automatically activates a determination of the data in result of the detection; and
a sender for transferring the data to a diagnostic application;
wherein the diagnostic application determines a cause of the disturbance by using the transferred data.

26. A computer program having code that executes on a processor, comprising:
detecting an occurrence of a disturbance;
automatically activating a determination of data in result of the detection;
transferring the data to the diagnostic application; and
determining a cause by the diagnostic application by using the transferred data
